(19) United States
(12) Patent Application Publication
(10) Pub. No.: US 2007/0273751 A1
(43) Pub. Date: Nov. 29, 2007

(54) System and methods for mobile videoconferencing

(76) Inventor: John A. Sachau, Colts Neck, NJ (US)

Correspondence Address: VALAUSKA & PINE LLC;One North Wacker Drive, Suite 4130, Chicago, IL, 60606, US

(21) Appl. No.: 11/710,348

(22) Filed: Feb. 23, 2007

Related U.S. Application Data
(63) Continuation-in-part of application No. 09/946,387, filed on Sep. 5, 2001, now abandoned.
(60) Provisional application No. 60/230,125, filed on Sep. 5, 2000.

(51) Int. Cl. H04N 7/15

(52) U.S. Cl. 348/14.02

(57) ABSTRACT

A system for videoconferencing having mobile capabilities, wherein at least one end of a communications link between two locations employs a wireless and/or fiber optically coupled transmitter/receiver pair or transceivers. The system enables a host at one end of the link to physically move around the location at which they are located, thereby enabling an audience at the other end of the link to be taken on a moving tour of the host's location and view changing scenes rather than viewing an image recorded from a stationary position at the second location as is the case when using conventional videoconferencing systems.

### PRIORITY NOTICE

This Patent application is a continuation-in-part of U.S. Non-Provisional application Ser. No. 09/946,387 filed Sep. 5, 2001, which claims the benefit of U.S. Provisional Application No. 60/230,125 filed Sep. 5, 2000.

### FIELD OF THE INVENTION

The present invention pertains to the field of teleconferencing, and more particularly to a videoconferencing system having mobile capabilities.

### BACKGROUND OF THE INVENTION

Teleconferencing has been used for more than thirty years by businesses, governments, educational institutions and other entities to enable parties in different geographic locations to communicate with one another. Teleconferencing eliminates the need for a first party to have to travel to a distant location to communicate in person with a second party, thereby saving the first party the time and expense associated with such travel. It also saves the second party the time and expense associated with having to entertain and/or host the first party.

Conventional teleconferencing systems typically operate by establishing a communications link over a telephone line between two different locations. Videoconferencing is a type of teleconferencing that allows parties at the two locations to speak to and to see one another. At each one of these locations, a camera, a monitor, a microphone, and a speaker are coupled to a device that interfaces with the telephone lines, wherein the camera and the microphone are used to record the visual and aural information that is to be transmitted to the other location, and the monitor and speaker are used to convey the visual and aural information recorded at the other location.

Conventional teleconferencing systems provide point-to-point communications. In a point-to-point conference, there are two participating sites with the ability to exchange data and share user applications, while permitting the participants to hold face-to-face meetings without leaving their location. Specifically, such systems provide parties with the ability to communicate between at least two fixed locations such as a conference room, meeting room, etc. Conventional teleconferencing systems also provide multi-point communications, which is participation of three or more sites simultaneously. Conventional teleconferencing systems suffer from several drawbacks. First, the production quality of such communications is typically poor. Second, such communications typically occur at speeds no greater than 384 Kbps. Third, these systems are more susceptible to eavesdropping and unauthorized access. It is a desire to ensure confidentiality and authenticity when teleconferencing. Finally, and most limiting, such systems have no mobility, such that the parties at one end of a communications link between two locations are only able to view what a stationary camera at the other end of the link records. The present invention overcomes the foregoing drawbacks by providing a teleconferencing system that employs wireless infrastructure to provide mobile capabilities and much improved production standards to such systems so that teleconferencing can be used in ways that were heretofore impossible.

### SUMMARY OF THE INVENTION

A growing application area in communications is teleconferencing, in which a group of users collaborate in an interactive procedure, such as a board meeting, a task force, a scientific discussion, or even a virtual classroom, but these systems have no mobility.

An object of the present invention is to provide a system for videoconferencing having mobile capabilities, wherein at least one end of a two-end communications link employs a wireless infrastructure coupled with a transmitter/receiver pair or transceivers. The system provides mobility to at least one party at one end of the link, i.e., the first location, thereby enabling such party to physically move around the first location and enabling a party at the other end of the link, i.e., the second location, to be taken on a moving tour of and view changing scenes from the first location rather than viewing an image of the location recorded from a stationary position, as is provided by conventional videoconferencing systems. In an alternative embodiment of the present invention, both ends of the communications link have mobile capabilities.

According to the present invention, a communication link connects two or more videoconferencing environments, otherwise referred to herein as locations. This link may include for example, data link, uplink, downlink, fiber optic link, point-to-point, multipoint, point-to-multipoint, private and public. A point-to-point link is a dedicated link that connects exactly two videoconferencing environments, whereas a multipoint link is a link that connects three or more videoconferencing environments. A point-to-multipoint link is a specific type of link which consists of a central videoconferencing environment that is connected to multiple videoconferencing environments. Any transmission of data that originates from the central videoconferencing environment is received by all of the peripheral videoconferencing environments while any transmission of data that originates from any of the peripheral videoconferencing environment is received not only by the central videoconferencing environment, but all peripheral videoconferencing environments as well. A private link is a link that is either owned by a specific entity or a link that is only accessible by a specific entity, whereas a public link uses a public utility or entity to provide the link and which may also be accessible by anyone. It is contemplated the present invention can use any of the aforementioned links to connect the components of two or more videoconferencing environments.

Types of communication links include Integrated Services Digital Network (ISDN), Asynchronous Transfer Mode (ATM), Digital Subscriber Line (DSL), Fiber Optic Network, Synchronous Optical Networking (SONET), Satellite Networks (SN), Wireless Wide Area Networks (WWAN), Frame Relay (FR), Worldwide Interoperability for Microwave Access (WiMAX), Ethernet and Broadband Integrated Services Digital Network (B-ISDN), to name a few. For example, the present invention utilizing a Satellite Network (SN) allows a mobile videoconferencing user at one location to send data to a satellite dish on the ground. The satellite dish throws the data to a sky satellite and that sends the data to another satellite dish on the ground, which then is sent to a portable device at another videoconference location.

Another communication link is Radio Frequency Networks (RF). Radio Frequency (RF) transmits and receives electromagnetic waves. Types of RF Networks include Extremely Low Frequency (ELF), Super Low Frequency (SLF), Ultra Low Frequency (ULF), Very Low Frequency (VLF), Low Frequency (LF), Medium Frequency (MF), High Frequency (HF), Very High Frequency (VHF), Ultra High Frequency (UHF), Super High Frequency (SHF), and Extremely High Frequency (EHF). ELF operates in the 3-30 Hz range while SLF operates in the 30-300 Hz range, for example communication with submarines. ULF operates in the 300-3000 Hz range, for example communication with underground mines. VLF operates in the 3-30 kHz range, for example communication with submarines and avalanche beacons. LF operates in the 30-300 kHz range, for example communication with navigation systems or Amplitude Modulation (AM) longwave broadcasting. MF operates in the 300-3000 kHz range, for example AM mediumwave broadcasting. HF operates in the 3-30 MHz range, for example shortwave broadcasts and aviation communications. VHF operates in the 30-300 MHz range, for example Frequency Modulation (FM) broadcasting and television broadcasting. VHF also includes line-of-sight ground-to-aircraft and aircraft-to-aircraft communications. UHF operates in the 300-3000 MHz range, for example television broadcasting and communication with mobile phones, wireless LAN and Bluetooth. SHF operates in the 3-30 GHz range, for example communication with microwave devise, wireless LAN, and radar. EHF operates in the GHz range, for example microwave radio relay. The RF Network also includes frequency wavelengths less than 3 Hz and greater than 300 GHz.

There is also a vast array of networks that connect these devices, including computer networks, public telephone networks, radio networks and television networks. More specifically, a network establishes communication between videoconferencing environments. Videoconferencing environments can establish communication by a few meters (e.g. via Bluetooth) or thousands of kilometers (e.g. via the Internet).

A mobile videoconference network is any set of mobile and/or fixed videoconferencing environments connected to each other. Examples of networks are a wide area network (WAN) that is the largest to ever exist, or a small home local area network (LAN).

A Wide Area Network (WAN) is any network whose communications links cross metropolitan, regional, or national boundaries. The Internet is the largest WAN, publicly accessible network of interconnected computer networks that transmits data by packet switching using the standard Internet Protocol (IP).

Local Area Networks (LAN) cover small geographic areas, like a home, office, or group of buildings and include Metropolitan Area Networks (MAN), Campus Area Networks (CAN), Personal Area Networks (PAN) and Wireless Local Area Networks (WLAN). WLAN utilizes spread-spectrum technology based on radio waves to enable communication between mobile videoconferencing environments in a limited area. This gives users the mobility to move around within a broad coverage area and still be connected to the network.

Ethernet is a computer networking technology. Basically, an Ethernet networks devices together, for example portable devices and fixed devices. Ethernet transfers data, for example, 10 Mega bits per second or 10,000,000 bits per second. Ethernet is a large, diverse family of frame-based computer networking technologies for local area networks (LANs)

Videoconferencing environments of the present invention include a recording component and a conveying component. A recording component records visual and aural information. For example, images can be recorded via a camera and sound can be recorded via a microphone. For purposes of this application, “record” means at least to temporarily, or transitorily, retain data or information. “Record” can also mean to store data or information, for example, as an archive for later retrieval. A conveying component conveys visual and aural information. For example, images can be conveyed via a display device and sound can be conveyed via an audio monitor. The recording component of location links with the conveying component of another location, and vice versa. Typically, the recoding component and conveying component are self-contained.

Mobile videoconferencing environments include a mobile or portable device equipment. Portable devices are hand-held or wearable devices, and include wireless devices, subscriber units, cellular telephones, personal data assistants, portable computers, laptops and personal computer. Portable and fixed devices include an encoder, decoder, and possibly an Ethernet. These devices may further include an antenna.

An encoder changes data into a code. The code may serve any of a number of purposes such as compressing information for transmission or storage, encrypting or translating from one code to another. This is usually done by means of a programmed algorithm, especially if any part is digital, while most analog encoding is done with analog circuitry. Encoders encrypt data to ensure data integrity and privacy. Typically, encoders convert analog signals to its digital representation Types of encoders include compressors and multiplexers, such as MPEG 4H.264, MPEG-1, MPEG-2.

A decoder is a device that does the reverse of an encoder, decrypting the encoding so that the original information can be retrieved. The same method used to encode is usually just reversed in order to decode. For example, a decoder re-converts a digital signal back to its original transmission signal such as analog. Types of decoders include MPEG 4H.264, MPEG-1, MPEG-2. Mobile videoconferencing environments also include a camera, microphone, display device, audio monitor, possible antenna, and access point(s).

A camera records images in real time according to the present invention. Cameras can be attached to a device, such as a computer or portable device, or can be a stand alone unit. For example, a camera can be integrated with a computer monitor in a desktop system or can be a camera enabled device such as a cellular phone.

A microphone is an acoustic to electric transducer that converts aural data into an electrical signal. Microphones can be attached to a device, such as a computer or portable device, or can be a stand alone unit.

A display device, also known as an information display, is a device conveying visual data, including tactile presentation of images (including text). While most common displays are designed to present information dynamically in a visual medium, tactile displays, usually intended for the blind or visually impaired, use mechanical parts to dynamically update a tactile image (usually of text) so that the image may be felt by the fingers. Examples of display devices include, a television, XGA monitor, plasma display, rear projector, video billboard, a screen located on the portable device or computer, or even the wall of a building in conjunction with a LCD/DLP projector. The videoconferencing system according to the present invention can use multiple displaying options such as camera in conjunction with a computer. Likewise, images can be viewed on one or multiple display devices. Additionally, images can be viewed on the display in “picture-in-picture” or “split-screen” format.

An audio monitor conveys aural data by converting signals into audible sound waves. Audio monitors can be attached to or integrated with a portable device or computer. Types of audio monitors include speakers, earphones, earbuds, stereophones, headsets, for example.

An antenna can be used to connect a portable or fixed device to an access point to send/receive data wired or wirelessly. An antenna converts radio frequency to transmit and receive electromagnetic waves.

An access point connects devices together to form a network. The access point can connect a wired or wireless network, and can relay data between wireless devices and wired devices. Several access points can link together to form a larger network that allows “roaming”. The present invention is a full-duplex system, which allows communication in all directions simultaneously.

The present invention discloses a mobile videoconferencing system such that at least one party, with mobile videoconferencing equipment, can move around a location while simultaneously exchanging visual and aural information data, such as audio and video, with at least one other party, with either a mobile videoconferencing equipment or fixed videoconferencing equipment.

An object of the present invention is to provide real time, or live, videoconferencing communication between parties, or participants. For purposes of this application, communicate is used to mean either recording and/or conveying data or information. At least one party is mobile allowing physical movement around a location. Mobile teleconferencing allows a participant to move around an environment, while communicating information via a mobile device.

Mobile videoconferencing is interactive such that both parties are synchronously speaking to one another with at least one party viewing the other. For example, according to the present invention, one party can ask a question and the other party can answer. Data communicated via mobile videoconferencing is typically visual and aural information, but can be other forms of data, such as sensory. Parties of mobile videoconferencing experience two-way audio and either one-way or two-way video. Ideally, the parties have two-way audio and two-way video. Two-way audio means parties transmit and receive aural information. Two-way video means parties transmit and receive images, or picture. One-way video means parties transmit or receive images.

In contrast to mobile videoconferencing, fixed videoconferencing allows a participant to communicate information from a fixed environment or location. Videoconferencing equipment at fixed environments includes fixed devices along with a camera, microphone, video monitor and audio monitor. A fixed device can be a desktop computer or even wireless devices, subscriber units, cellular telephones, personal data assistants, portable computers, laptops, etc. An example of a fixed videoconferencing environment is the Middlesex County Fire Academy, a state of the art training facility located in Sayreville, Middlesex County, New Jersey. The present invention can use this facility as a fixed environment to communicate with participants not located on site. The participants not located on site can communicate with this fixed environment via portable devices. The Middlesex County Fire Academy can also be a mobile videoconferencing environment if the instructor moves beyond the four walls of the conference room. For example, an instructor can be putting out a chemical fire on the training ground while communicating live and interactively with other classrooms around the world. Other examples of fixed environments include conference rooms, personal computers, etc.

Mobile, or wireless, videoconferencing includes at least one party at a mobile environment. A “mobile-to-fixed” teleconference is communication between at least one mobile environment and at least one fixed environment. For example, a teacher videoconferences from a classroom to one or more students walking around campus interacting with the teacher via a mobile, or portable, device. In the alternative, a teacher videoconferences from a mobile environment, for example a museum, walking around while explaining artifacts to a classroom of one or more students. A “mobile-to-mobile” teleconference is communication between one or more mobile videoconferencing environments.

The present invention reduces the cost of group meetings, including travel related costs, when participants must travel a great distance to attend a meeting. The present invention also provides mobile videoconferencing communication between parties in different locations around the world.

The present invention increases productivity by providing the ability to be in several places at once. Mobile videoconferencing is an interactive tool that incorporates audio, video, computing and communication technologies to allow people in different locations to electronically collaborate face-to-face, in real time, and share all types of information including data, documents, sound and picture. It is contemplated other equipment can be integrated with the present invention to communicate sensory data, such as smell, night vision, and touch. It is also contemplated that equipment can be integrated with the present invention to measure and analyze biological data, such as technologies that measure and analyze human body characteristics, such as fingerprints, eye retinas and irises, voice patterns, facial patterns and hand measurements.

The present invention allows for multi-point meetings. Mobile videoconferencing allows a meeting of various participants from different locations across the globe, including across time zones and international boundaries.

Mobile videoconferencing reinforces relationships. Mobile videoconferencing allows parties to view facial expressions and body language of others. These are both important aspects of communication that are lost with a basic telephone call and conventional teleconferencing systems.

Mobile videoconferencing also improves communication effectiveness. Mobile videoconferencing allows parties to “see”, which is more effective than trying to understand only a verbal description. Likewise, parties can ask questions resulting from that seen on the video monitor.

In addition to real time communication between environments, the mobile videoconferencing sessions can be recorded with the ability to archive and replay them in the future. Data such as voice and images can be recorded at mobile and/or fixed environments, for example VHS, microchips, DVD, on the portable or fixed device, or even on devices attached to the videoconferencing equipment. It is further contemplated images displayed in picture-in-picture format can be recorded for later playback.

The present invention reduces the cost of communication equipment and operational costs. For example, mobile videoconferencing eliminates the need for a satellite truck and crew at news locations. Mobile videoconferencing allows news at the White House to be communicated to a television studio New York City.

The present invention can use various protocols to link environments, for example, internet protocol (IP), Open Systems Interconnection (OSI), and point-to-point (PPP) to name a few. Mobile videoconferencing according to the present invention is easily integrated with existing communication infrastructure.

Another object of the present invention is to utilize spread spectrum techniques, or using the for better range, communication of more data, and use of less power. Spread-spectrum techniques are methods by which energy generated at one or more discrete frequencies is deliberately spread or distributed in the frequency. Use of the radio frequency spectrum with higher order modulations offers less interference from both unintentional (unlicensed), and intentional (jamming) sources, thereby establishing more secure communications. Additionally, use of spread spectrum techniques lowers probability of intercept (LPI) and lowers probability of detect (LPD). Hence multiple streams of video and audio are feasible.

The present invention reduces the amount of paper waste. Mobile videoconferencing can be used to convey information that is typically distributed via printed material, such as trade show information.

The present invention is advantageous to numerous applications, both indoor and outdoor environments, to enhance and streamline videoconferencing communication. Applications include, for example, military training, fire training, domestic preparedness and homeland security. Following are a few examples in which mobile videoconferencing are desirable.

The present invention can be utilized for various training or educational applications. Schools, universities, colleges or training facilities can use the present invention to provide live and interactive instruction in classrooms around the nation and the world, better preparing the participants on various subjects. Mobile videoconferencing creates improved evaluation, instruction and coaching. For example, the battle of Gettysburg can be re-enacted from the actual location to students in an inner city classroom. The instructor can be on horseback talking to the students and answering questions, calling them by name.

The present invention can enhance the learning experience for all types of subjects, such as history, environmental science, and engineering. For example, students in the United States can mobile videoconference with a teacher in Mexico to learn a foreign language. Educational content in enhanced by bringing information from various locations around the world into the classroom. For example, a teacher can educate students from various locations, like a dairy farm in Vermont. Likewise, educational content can be brought from the classroom into various locations. For example, a teacher can teach students who are ill and in the hospital. Mobile videoconferencing equipment can be transported anywhere in the hospital to any room and also brought outside if needed.

The present invention would be advantageous to military training. Deployed soldiers can communicate information from the field back to troops preparing to leave for duty. For example, a commander in Iraq could have a mobile videoconference with troops in Kentucky showing them exactly what to expect, the terrain they have to defend, and how to apply concepts learned in boot camp. The troops in Kentucky can ask questions and receive answers real time from the commander. Likewise, soldiers can communicate between one military field and another military field.

Training can be provided to first responders, for example police, paramedics and firefighters, to train and instruct them on situations that may arise during the performance of their duties. For example, training at the Middlesex County Fire Academy in New Jersey can be live and interactive with firefighters in California. The present invention can also be used to assist American organizations, for example, Red Cross, to train individuals on the care for the sick and wounded, and relief to those suffering from floods, fire, disease, and other natural calamities.

Hospitals can use the present invention for training staff. For example, the hospital can transmit information to a mobile environment, such as an airport in the event of a real life catastrophe to communicate care for the wounded. Conversely, the hospital can receive information such as training from a mobile location, for example an airport where participants are assisting in a simulated airport catastrophe.

Another example is aviation training. An aviation mechanic could have a training session out of the flight tarmac with an actual jet. For example, a mechanic in Florida can teach in real time video and audio to students located remotely in Chicago. The mechanic can show how to repair a jet engine, with the remote students asking questions.

With the present invention job training can be provided to individuals located anywhere in the world, promoting job training and career development. Skills for a particular job can be taught, for example, a construction worker can learn how to build a house viewing people performing the work real time and engage in live interactive question and answer sessions. More impressive would be a worker building a bridge or sky scraper having a live video conference with students.

Training could be provided to the transportation industry, for example the MTA in New York City or the CTA in Chicago. Transportation companies world-wide can partner together to interchange information such as operating procedures, repair and extraction techniques from subway systems to name a few.

Learning how to play certain games is less burdensome. A golf instructor can teach lessons and evaluate a golf student, with each located on different golf courses in different parts of the world, for example, an instructor in Arizona can see and correct the swing of a student in Japan. The instructor can even teach a third student at another location, such as at a retail store in Canada. The present invention also allows two or more parties to interactively play a game real time.

The present invention can be used in libraries to communicate live content from a field of study, such as an Indian reservation, to groups of people located at libraries around the world.

The present invention is applicable to investment securities. A firm can offer a real time research call from a company's headquarters giving investors the opportunity to ask questions eliminating the typical procedure of the analyst asking questions, writing-up a report, and sending it out to the investor.

The present invention allows certain industries to provide additional content. For example, movie theaters can show a fashion show in Milan, Italy or an opera performance in New York that is mobile videoconferenced to the movie theatre. Another example includes a fashion show on a beach in Spain, with buyers in New York, Los Angeles and Japan.

The present invention can mitigate risk. An insurance underwriter who manages risk for the insurance company can monitor progress of a building being built anywhere in the world real time and discuss changes needing immediate attention and implementation. Insurance adjusters can be taken on a tour by the homeowner to view property damage. Chemical companies can train employees or even other chemical companies on proper handling, engineering, and safety tips. Items stored in warehouses can be viewed to alleviate risk of things that might be stored improperly or too high. Mistakes and risks can be corrected immediately.

The present invention can act as a form of surveillance. A location can be observed such that terrorists and trespassers can be immediately warned and notified that the police are on there way. Likewise, the activity and behavior of a person, for example, baby sitter or elderly care nurse can be monitored, supervised, corrected and communicated with in a live interactive method.

It is further contemplated that the components of the present invention can be packaged in various forms, for example, a balloon or a rock, for inconspicuous surveillance. Various forms allow the monitoring of activity in certain areas, such as inner city or high terrorist areas, and communicate this activity back to another videoconferencing environment. A balloon can contain a camera and microphone, to survey activity from above. The balloon can be tethered to an item within the area or simply hover. A rock can contain a camera and microphone and be used to survey activity on the ground level, such as communication between terrorists. The rock can be artificial and made from fiberglass such that data signals can pass there through. These forms can further include a display device and audio monitor such that communication can be conveyed to the parties being surveyed. In addition, these forms can include sensory equipment such that they can survey at night as well as detect drugs or explosives. It is further contemplated that these forms can be strategically placed for surveying, such as remote controlled or even air dropped from parachutes.

Most importantly, the present invention saves lives. In addition to the forms mentioned above, mobile videoconferencing equipment can be packaged in a sentry, a soldier stationed at a place to stand guard, or a robot. Military soldiers and first responders can assess life-threatening situations from afar.

The present invention can streamline the real estate industry. Potential purchasers can remotely view a home for sale while asking the realtor questions. For example, a buyer in New York can view houses—inside and out—of a new development in Florida, and ask questions about the property. New home sales people can communicate to construction workers the upgrades a home buyer purchased. Likewise, the home buyer can view the upgrades and verify accuracy. This is advantageous to the home buyer who may not be permitted on the property during construction because of insurance reasons.

The present invention can assist with consumer shopping. For example, consumers can mobile videoconference with a retail store. The real time and interactive capabilities of the present invention allows consumers to view goods around the store, ask questions and even buy it, while not physically being there. A potential buyer for large items, like agricultural equipment, car or boat, can view these items wherever they are located in the world. The buyer can ask questions and view live demonstrations of the product.

The present invention can replace destination travel. Travelers can participate in an African safari and communicate with animals up-close without leaving their home.

The present invention can be used at auctions. Large items, such as farming equipment, can be mobile videoconferenced to auction houses with real time demonstrations. Likewise, bidders do not have to be located at the auction house to bid on an item, but can mobile videoconference their bid to the auctioneer.

The present invention can assist in fund raising. For example, an artist can mobile videoconference from his studio to a fundraising organization. Likewise, an artist can mobile videoconference from the San Francisco harbor while painting the harbor at sunset to entice more people to join the fund raiser. The real time and interactive capabilities of the present invention allow purchasers to view a work of art from the artist's studio, a harbor, a beach, a field and ask questions and even buy it. The artist can communicate his creation and even tell the story as to his inspiration and the importance of the location he is mobile videoconferencing from.

The present invention gives people the ability to visit different locations of interest around the world while not physically being there. People can learn about historical sites, for example Bethlehem, Nazareth and Jerusalem while seeing them remotely and communicating with tour guides at the historical sites. Travel reservation organizations can mobile videoconference from a beach in Hawaii, a golf course in Florida or a ski slope in Colorado to a fixed location, big screen at a retail store, where interested parties can view the locations and ask questions. The travel reservation organizations can likewise mobile videoconference to one or more mobile locations, where interested parties are simultaneously performing other tasks. Additionally, appearances by famous people, such as authors and actors can be made more efficient. They can interact with an audience anywhere in the world.

The present invention allows retail stores to enhance the goods and services provided to customers. A customer in a sporting goods store can interact with a golf expert who is playing on a golf course. The expert can answer questions regarding equipment as well as showing circumstances when certain pieces of equipment are desired. Other example include a customer shopping in a grocery store can ask a farmer why his particular product is organic or how it is grown. A department store can mobile videoconference a fashion show allowing customers to ask questions of the models and designers.

The present invention is applicable to trade shows. Manufacturers of products can showcase their ideas and expedite the time it takes to bring new products to the marketplace. For example, a military general can attend a military trade show without having to be at the convention center and even record product information (to show other military personnel at a later time). The military general can even view demonstrations of new model tanks outside the convention center, eliminating the need for prototypes.

Another advantage is that the present invention can enhance advertising and public relations. Video billboards convey pre-recorded video, while the present invention can allow for real time, or live, and even interactive communication. For example, a person standing in Times Square, N.Y. views a large video billboard advertising a theme park or new vehicle model and can ask questions regarding the product or service advertised. The video billboard answers those questions, not only communicating the answer to the person asking, but also all other persons in Times Square.

Sporting events at one location can be mobile videoconferenced to another location. For example, a sporting arena in the United States can communicate a soccer game to a location in Afghanistan. The location in Afghanistan can have a large video monitor, such as an eight foot by eight foot screen, to view the game being played from the field in the United States. The present invention allows players to communicate during and after the game with spectators or other players. Additionally, a college or professional sporting scout can view athletes playing a sport on the playing field. For example, a scout can communicate with the coach and/or the athlete to perform certain maneuvers such as run a specific play. The scout can view the athlete running the play from numerous angles. The scout can provide the athlete feedback such as strengths and weaknesses, or correct the athlete and have him/her run it again to see how quickly he/she learns. The present invention allows the scout to communicate directly with the athlete, which also may assist in assessing the intelligence and attitude of the athlete.

Mobile videoconferencing is applicable to customer service applications. The present invention strengthens business relationships by increasing contact with customers. Beyond the salesperson from a company, mobile videoconferencing allows the customer to meet more internal employees. Companies can improve customer service by remotely interacting with customers. For example, an engineer can show a vendor problems with a purchased product, such as a John Deere equipment. Mobile videoconferencing can provide real time “how to” instructions for assembling or repairing items, for example a boat mechanic on-location in a harbor having a problems with a yacht engine and requiring assistance from the head mechanic. The present invention allows the head mechanic to observe and instruct the mechanic without traveling to the location.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will be described in conjunction with the appended drawings provided to illustrate and not to the limit the invention, where like designations denoted like elements, and in which:

FIG. 1 shows a block diagram of a first exemplary embodiment of a teleconferencing system having mobile capabilities according to the present invention;

FIG. 2 shows a detailed block diagram of a first exemplary embodiment of a teleconferencing system having mobile capabilities according to the present invention;

FIG. 3 shows a schematic of the exemplary embodiment of FIGS. 1 and 2 according to the present invention;

FIG. 4 shows a detailed block diagram of another exemplary embodiment of a videoconferencing system having mobile capabilities according to the present invention;

FIG. 5 graphically illustrates an application embodiment of a videoconferencing system having mobile capabilities according to the present invention;

FIG. 6 graphically illustrates an alternate application embodiment of FIG. 5 of a videoconferencing system having mobile capabilities according to the present invention;

FIG. 7 graphically illustrates an application embodiment of a mobile videoconferencing system having mobile capabilities according to the present invention;

FIG. 8 graphically illustrates a packaging embodiment of mobile video conferencing equipment having mobile capabilities according to the present invention;

FIG. 9 graphically illustrates an application embodiment of a mobile videoconferencing system having mobile capabilities according to the present invention; and

FIG. 10 graphically illustrates an application embodiment of a mobile videoconferencing system having mobile capabilities according to the present invention.

### DETAILED DESCRIPTION OF THE INVENTION

The present invention discloses a mobile videoconferencing system such that at least one party, with mobile videoconferencing equipment, can move around a location while simultaneously exchanging audio and video data with at least one other party, with either mobile videoconferencing equipment or fixed videoconferencing equipment.

The present invention discloses a teleconferencing system 10 having mobile capabilities so that a conferee, i.e., an audience, at a first location can be taken on a walking or otherwise moving tour by a conferee, i.e., host, at a second location. At the first location, the components employed are the same ones employed at one end of a conventional videoconferencing system link. Specifically, a monitor and a speaker are used to enable the audience to see and hear, respectively, communications from the host at the second location. In addition, a camera and a microphone at the first location enable the host at the second location to see and hear the audience. The monitor, speaker, camera and microphone are all coupled to a compression/decompression (CODEC) device that serves as the interface to and from the ISDN (integrated service digital network) lines over which communications with the second location occur.

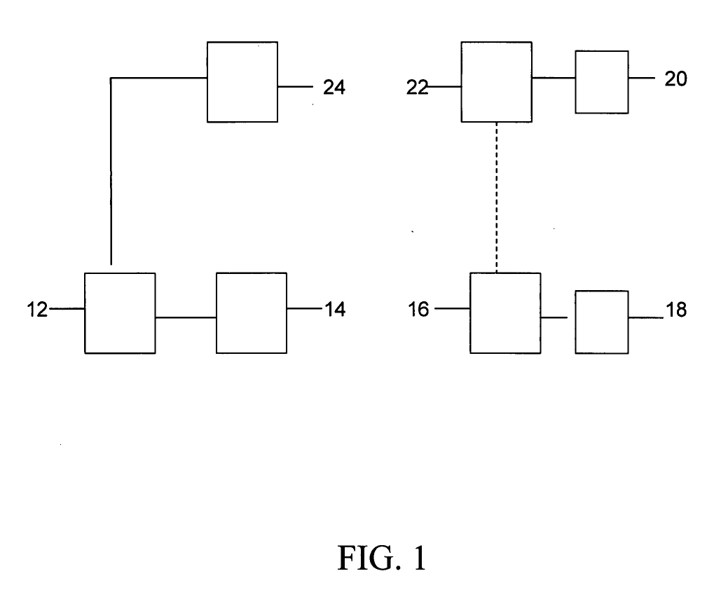

FIG. 1 shows the components of system 10 that are employed at the second location. A second CODEC 12 outputs video and audio signals received over the ISDN lines from the first location to a transmitter 14 which transmits such signals to a remote receiver 16 located elsewhere on the premises of the second location. Remote receiver 16 is coupled to a video and audio monitor 18 that enables the host to view and hear the audience at the first location.

A remote camera 20 records the host and is coupled to a remote transmitter 22 that transmits the recorded video and audio signals, e.g., of the host at the second location, to a receiver 24. The video and audio are input by receiver 24 to CODEC 12 which transmits the signals over the ISDN lines to the audience at the first location, thereby enabling the audience to see and hear the host at the second location.

Like conventional videoconferencing systems, system 10 enables the audience and the host both to see one another and to converse with one another. However, unlike conventional systems, system 10 enables the host to move freely around the second location. This mobility enables the host to take the audience at the first location on a moving tour of the second location. Thus, the audience can ask the host to stop and examine things that the audience sees that are of interest to them, and/or they can ask questions of persons that the host encounters while touring the second location. By employing this mobility, the present invention uses Codec's in ways such hardware was never originally intended to be used.

The mobility of system 10 results from transmitters 14 and 22 and receivers 16 and 24 being implemented either as wireless components or as components that are coupled to one another using lightweight, fiber optic cable. Alternatively, transmitters 14 and 22 and receivers 16 and 24 could be implemented using a combination of wireless and fiber optically coupled components. The transmitter/receiver pairs 14 and 16, and 22 and 24 provide full duplex video and audio communications between the first and second locations. These components enable videoconferencing to be used in ways never before done.

For example, system 10 can enable the audience at the first location to be taken on a tour of a vineyard at the second location, wherein the host is a vineyard employee who strolls the vineyard grounds using camera 20 to show the audience the vineyard while answering any questions the audience may have. The audience at the first location can be situated in any meeting place, such as a hotel ballroom, a school auditorium, a lecture hall, a movie theater, a tent, a restaurant, a department store, etc. The use of wireless and/or optically coupled components results in improved production quality compared to conventional videoconferencing systems. Moreover, using such components and the first and second CODECs together with multiple ISDN lines enables videoconferencing to occur at speeds greater than 384 Kbps. Various internet service providers (ISP's) offer varying speeds from 128 kbps up to 20 Mbps, although 768 k or above offers better video quality.

System 10 can also be used for numerous other purposes. For example, system 10 can be used by a museum to provide the audience with a tour of different salons and exhibits in a museum, or it can be used by a travel agent to provide the audience with a tour of the different accommodations and activities of a resort, or it can be used by a university to provide the audience with a tour of the university. Thus, the locales where system 10 can be used are limitless. It is understood that the audience at the first location can be comprised of any number of persons, and that multiple hosts at the second location can be involved in a videoconference. In addition, more than two locations can be simultaneously included in a videoconference using the present invention. Also, the mobility provided by system 10 enables the host to walk, ride a bicycle, drive a vehicle, or otherwise move while taking the audience on a moving tour of the second location.

In an alternative embodiment of the present invention, two transceivers are used in place of transmitter/receiver pairs 14 and 16, and 22 and 24. In another alternative embodiment of the present invention, the components shown in FIG. 1 are used at both the first and second locations so that system 10 has mobile capabilities at both ends of the communications link. In still another alternative embodiment of the present invention, codec 12 is implemented as a portable device that eliminates the need to use one of the transmitter/receiver pairs or one of the transceivers.

Although communications using system 10 will typically occur at present over ISDN lines, such communications can occur over other communications links, such as microwave, satellite systems, high speed land lines or standard telephone wire. The present invention can also be used to deliver videoconferencing over the Internet.

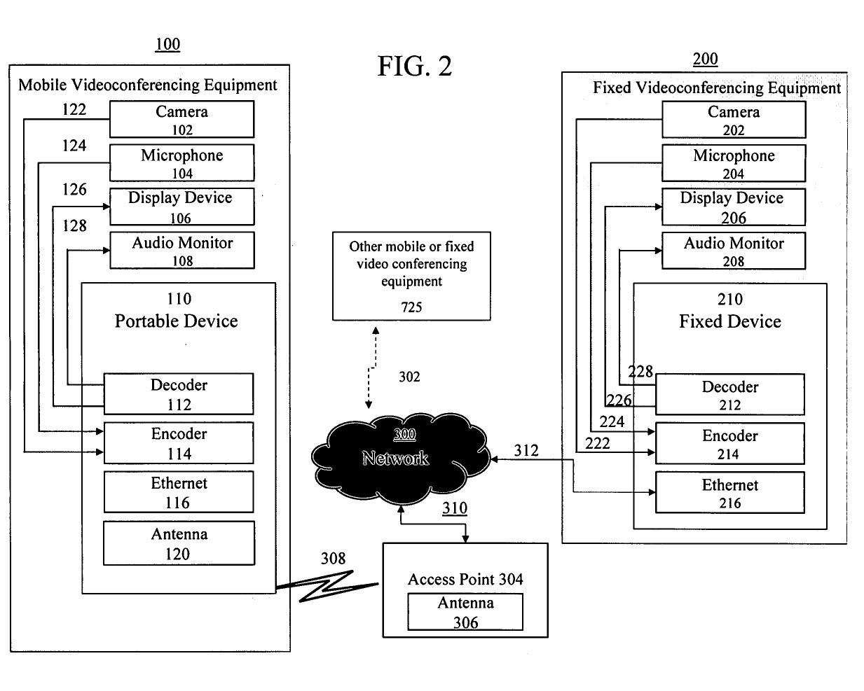

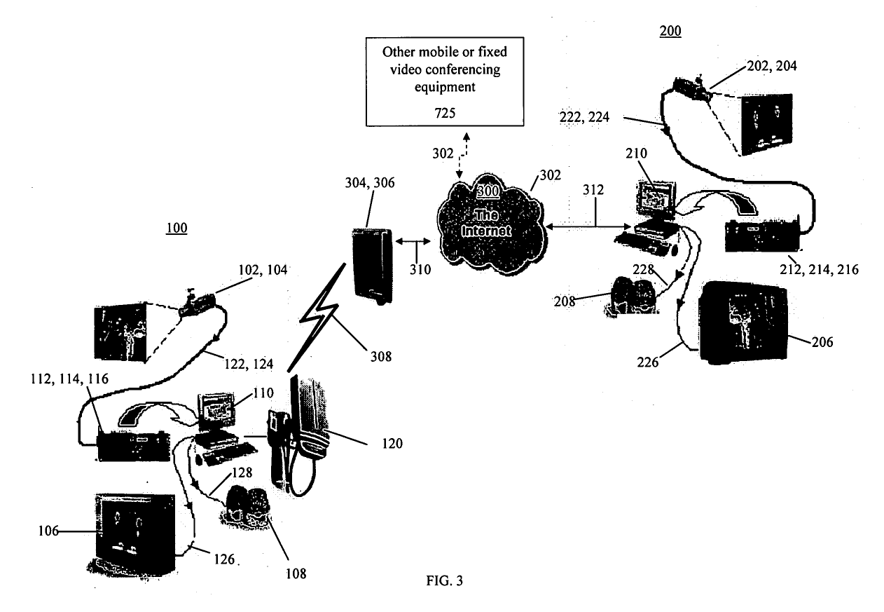

FIG. 2 is a detailed block diagram of mobile video conferencing equipment 100 in communication with fixed videoconferencing equipment 200. FIG. 3 is a schematic of the exemplary embodiment of FIG. 2 according to the present invention. Mobile videoconferencing equipment 100 includes a camera 102, microphone 104, display device 106, audio monitor 108 and portable device 110. The microphone 104 can be attached to or integrated with the portable device 110 or a stand alone unit.

The display device 106 show images wherein the images can be viewed on one or multiple display devices. Additionally, the images can be viewed via “picture-in-picture” format. Mobile videoconferencing systems can use multiple displaying options. In a mobile environment, a display device 106 can be a screen located on the portable device 110. Like microphone 104, audio monitor 108 can be attached to or integrated with the portable device 110.

The portable device 110 includes a CODEC 112, 114 and an Ethernet 116. The CODEC 112, 114 is the core (or “engine”) of a mobile videoconference system and is responsible for all of the encoding 114 and decoding 112 of data (audio, video). The encoder 114 converts and compresses video and audio signals so they can be transmitted over existing telecommunications network. The decoder 112 reverses the process at the receiving end. All mobile videoconferencing systems work in a full duplex mode, i.e., encoding and decoding of audio-video in both directions simultaneously.

The Ethernet 116 connects devices in close proximity. A transceiver, for example wireless transceiver, transmits and receives data via antenna 120. Antenna 120 transmits and receives data over communication link 308 to and from antenna 306 of an access point 304. The access point 304 communicates with the portable device 110 through a secure method to ensure data integrity and privacy.

For embodiments of the present invention where no access point exists, the present invention can utilize any available satellite system. Typically satellite systems provide one-way video, but can provide two-way video for use with the present invention. In situations where only one-way video is accessible, a two-way audio complements the present invention.

Fixed videoconferencing equipment 200 includes a camera 202, microphone 204, display device 206, audio monitor 208 and fixed device 210. The microphone 204 can be attached to the fixed device 210 or be free-standing.

The display device 206 show images wherein the images can be viewed on one or more display devices 206. Additionally, images can be viewed via “picture-in-picture” format. Fixed videoconferencing systems can use multiple displaying options. For example, desktop systems show video images in a small window on the computer monitor, whereas room-sized systems can have one or more large video monitors that display to a local audience (as well as to a remote audience). Similar to the microphone 204, audio monitor 208 can be attached to the fixed device 210 or free standing.

The fixed device 210 includes a CODEC 212, 214 and an Ethernet 216. The CODEC 212, 214 is the core (or “engine”) of a fixed videoconference system and is responsible for all of the encoding 214 and decoding 212 of data (audio, video). The encoder 214 converts and compresses video and audio signals so they can be transmitted over an existing network. The decoder 212 reverses the process at the receiving end. All mobile videoconferencing systems work in a full duplex mode, i.e., encoding and decoding of audio-video in both directions simultaneously. The Ethernet 216 connects devices in close proximity, here the fixed device 210 and network 300 over communication link 312.

Network 300 is the connection that carries data between the equipment communicating with one another. The size of the connection and the ability to access the network in a consistent manner, determines both video performance and quality of service. For example, the connection can range from wide area networks (WAN) such as ISDN lines or satellite based lease lines to a dedicated PRI/T-1 connection or access to a local area network. The network 300 includes an access point 304 with antenna 306 that transmits and receives data to and from the network 300 via communication link 310. All fixed videoconferencing systems work in a full duplex mode, i.e., encoding and decoding of audio-video in both directions simultaneously.

The mobile videoconferencing equipment 100 communicates with the fixed teleconferencing equipment 200 via the network 300. A party of mobile videoconferencing equipment 100 speaks into the microphone 104 while images are recorded on a camera 102. Simultaneously, audio and video can be recorded for playback at a later time. The audio is sent via link 124 and video is sent via link 122 to the encoder 114 of the portable device 110. The encoder 114 encodes the data. The Ethernet 116 sends the encoded data to the antenna 120 for transmission to the antenna 306 of the access point 304. The access point 304 sends the encoded data to the network 300 via communication link 310. Network 300 then transmits the encoded data via link 312 to the Ethernet 216 of the fixed videoconference equipment 200. The Ethernet 216 receives the encoded data and the decoder 212 decodes the data. The audio of the decoded data is sent via link 228 to the audio monitor 208 and the decoded video data is sent via link 226 to the display device 206.

The process is reversed when the party at the fixed videoconference location communicates to the party at the mobile videoconference location. The party of fixed videoconferencing equipment 200 speaks into the microphone 204 while images are recorded on a camera 202. Simultaneously, audio and video can be recorded for playback at a later time. The audio is sent via link 224 and the video is sent via link 222 to the encoder 214. The encoder 214 encodes this information. The Ethernet 216 sends the encoded data to the network 300 via communication link 312. The network 300 sends the encoded data via link 310 to the access point 304. The antenna 306 of the access point 304 transmits the encoded data via communication link 308 to the antenna 120 of the portable device 110. The Ethernet 116 receives the encoded data and the decoder 112 decodes the data. The audio of the decoded data is sent to the audio monitor 108 via link 128 and the decoded video data is send to the display device via link 126. Equipment where the audio monitor is separate from the video monitor allows a party to walk away from the video monitor while still being able to speak and hear other parties.

It is further contemplated other mobile or fixed videoconferencing equipment 725 can communicate with the network 300 via communication link 302. Thus, more than two parties can mobile videoconference together.

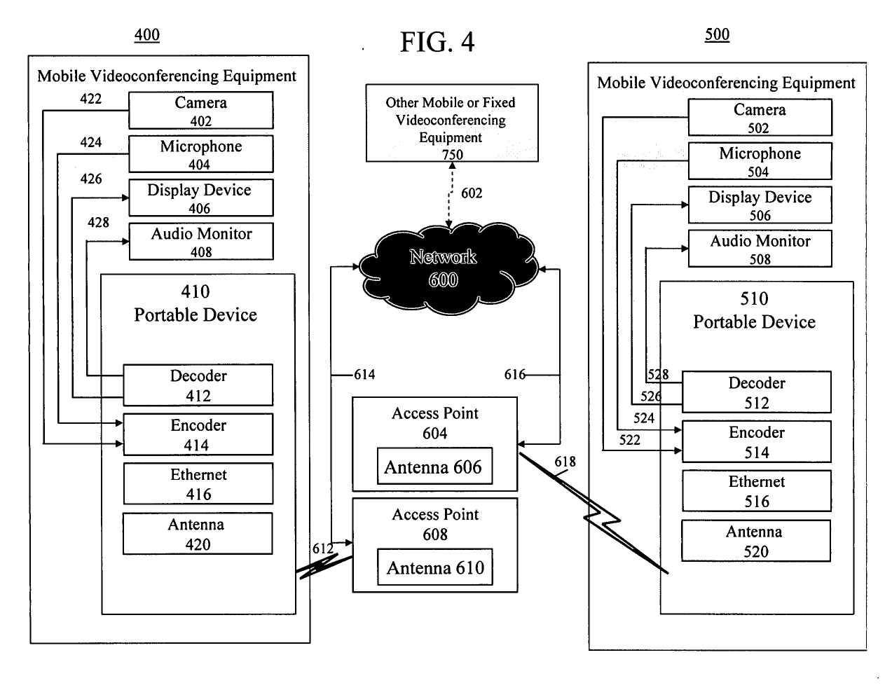

FIG. 4 is a detailed block diagram of mobile video conferencing equipment 400 in communication with mobile videoconferencing equipment 500. Mobile videoconferencing equipment 400 includes a camera 402, microphone 404, display device 406, audio monitor 408 and portable device 410. The microphone 404 can be attached to or integrated with the portable device 410 or a stand alone unit.

The display device 406 show images wherein the images can be viewed on one or multiple display devices. Additionally, the images can be viewed via “picture-in-picture” format. Mobile videoconferencing systems can use multiple displaying options. In a mobile environment, a display device 406 can be a screen located on the portable device 410. Like microphone 404, audio monitor 408 can be attached to or integrated with the portable device 410.

The portable device 410 includes a CODEC 412, 414 and an Ethernet 416. The CODEC 412, 414 is the core (or “engine”) of a mobile videoconference system and is responsible for all of the encoding 414 and decoding 412 of data (audio, video). The encoder 414 converts and compresses video and audio signals so they can be transmitted over existing telecommunications network. The decoder 412 reverses the process at the receiving end. All mobile videoconferencing systems work in a full duplex mode, i.e., encoding and decoding of audio-video in both directions simultaneously.

The Ethernet 416 connects devices in close proximity. A transceiver, for example wireless transceiver, transmits and receives data via antenna 420. Antenna 420 transmits and receives data over communication link 612 to and from antenna 610 of an access point 608. The access point 608 communicates with the portable device 410 through a secure method to ensure data integrity and privacy.

For embodiments of the present invention where no access point exists, the present invention can utilize any available satellite system. Typically satellite systems provide one-way video, but can provide two-way video for use with the present invention. In situations where only one-way video is accessible, a two-way audio complements the present invention.

Mobile videoconferencing equipment 500 includes a camera 502, microphone 504, display device 506, audio monitor 508 and portable device 510. The microphone 504 can be attached to or integrated with the portable device 510 or a stand alone unit.

The display device 506 show images wherein the images can be viewed on one or multiple display devices. Additionally, the images can be viewed via “picture-in-picture” format. Mobile videoconferencing systems can use multiple displaying options. In a mobile environment, a display device 506 can be a screen located on the portable device 510. Like microphone 504, audio monitor 508 can be attached to or integrated with the portable device 510.

The portable device 510 includes a CODEC 512, 514 and an Ethernet 516. The CODEC 512, 514 is the core (or “engine”) of a mobile videoconference system and is responsible for all of the encoding 514 and decoding 512 of data (audio, video). The encoder 514 converts and compresses video and audio signals so they can be transmitted over existing telecommunications network. The decoder 512 reverses the process at the receiving end. All mobile videoconferencing systems work in a full duplex mode, i.e., encoding and decoding of audio-video in both directions simultaneously.

The Ethernet 516 connects devices in close proximity. A transceiver, for example wireless transceiver, transmits and receives data via antenna 520. Antenna 520 transmits and receives data over communication link 618 to and from antenna 606 of an access point 604. The access point 604 communicates with the portable device 610 through a secure method to ensure data integrity and privacy.

For embodiments of the present invention where no access point exists, the present invention can utilize any available satellite system. Typically satellite systems provide one-way video, but can provide two-way video for use with the present invention. In situations where only one-way video is accessible, a two-way audio complements the present invention.

Network 600 is the connection that carries data between the equipment communicating with one another. The size of the connection and the ability to access the network in a consistent manner, determines both video performance and quality of service. For example, the connection can range from wide area networks (WAN) such as ISDN lines or satellite based lease lines to a dedicated PRI/T-1 connection or access to a local area network. The network 600 includes an access point 608 with antenna 610 that transmits and receives data to and from the network 300 via communication link 614. In addition, network 600 includes access point 604 with antenna 606 that transmits and receives data to and from the network 300 via communication link 616. All mobile videoconferencing systems work in a full duplex mode, i.e., encoding and decoding of audio-video in both directions simultaneously.

The mobile videoconferencing equipment 400 communicates with the mobile teleconferencing equipment 500 via the network 600.

A party of mobile videoconferencing equipment 400 speaks into the microphone 404 while images are recorded on a camera 402. Simultaneously, audio and video can be recorded for playback at a later time. The audio is sent via link 424 and video is sent via link 422 to the encoder 414 of the portable device 410. The encoder 414 encodes the data. The Ethernet 416 sends the encoded data to the antenna 420 for transmission via communication link 612 to the antenna 610 of the access point 608. The access point 608 sends the encoded data to the network 600 via communication link 614.

Network 600 then transmits the encoded data via link 616 to the antenna 606 of access point 604. The access point 604 sends the encoded data via communication link 618 to the antenna 520 of portable device 510. Ethernet 516 of the mobile videoconference equipment 500 receives the encoded data and the decoder 512 decodes the data. The audio of the decoded data is sent via link 528 to the audio monitor 508 and the decoded video is sent via link 526 to the display device 506.

The process is reversed when the party at the mobile videoconference location 500 communicates to the party at the mobile videoconference location 400.

A party of mobile videoconferencing equipment 500 speaks into the microphone 504 while images are recorded on a camera 502. Simultaneously, audio and video can be recorded for playback at a later time. The audio is sent via link 524 and video is sent via link 522 to the encoder 514 of the portable device 510. The encoder 514 encodes the data. The Ethernet 516 sends the encoded data to the antenna 520 for transmission via communication link 618 to the antenna 606 of the access point 604. The access point 604 sends the encoded data to the network 600 via communication link 616.

Network 600 then transmits the encoded data via link 614 to the antenna 610 of access point 608. The access point 608 sends the encoded data via communication link 612 to the antenna 420 of portable device 410. Ethernet 416 of the mobile videoconference equipment 400 receives the encoded data and the decoder 412 decodes the data. The audio of the decoded data is sent via link 428 to the audio monitor 408 and the decoded video is sent via link 426 to the display device 406.

It is further contemplated other mobile or fixed videoconferencing equipment 750 can communicate with the network 600 via communication link 602. Thus, more than two parties can mobile videoconference together.

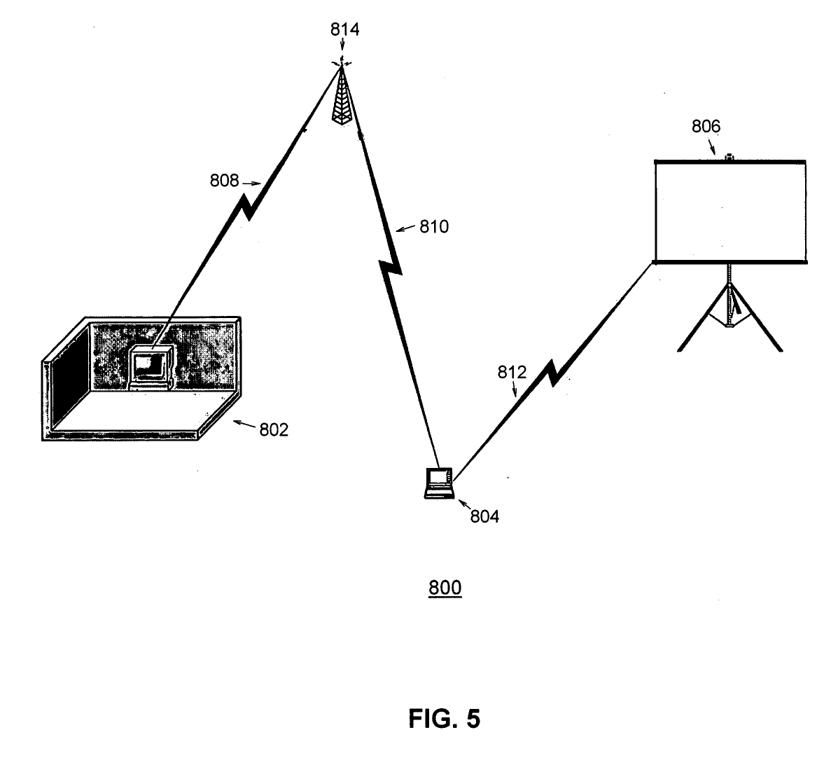

FIG. 5 graphically illustrates an application embodiment of a videoconferencing system 800 having mobile capabilities according to the present invention. A fixed videoconferencing environment 802 communicates with mobile videoconferencing environment 804 that further communicates with yet another mobile videoconferencing environment 806. For example, the fixed videoconferencing environment 802 is a control center, or conference room, at a police station. Police out in the field utilize mobile videoconferencing equipment 804 such as a laptop, to communicate with the control center. Data is transmitted from the control center via radio frequency 808 to a radio tower 814. Radio tower 814 transmits the data via radio frequency 810 to the laptop. Likewise, the police can communicate data from the laptop to the control center. Additionally, information from the laptop can be communicated to another mobile videoconferencing environment 806 via radio frequency 812. For example, the laptop communicates information to a hostage environment, wherein the hostages view instructions on a projection screen. In turn, the hostages can communicate with the police in the field.

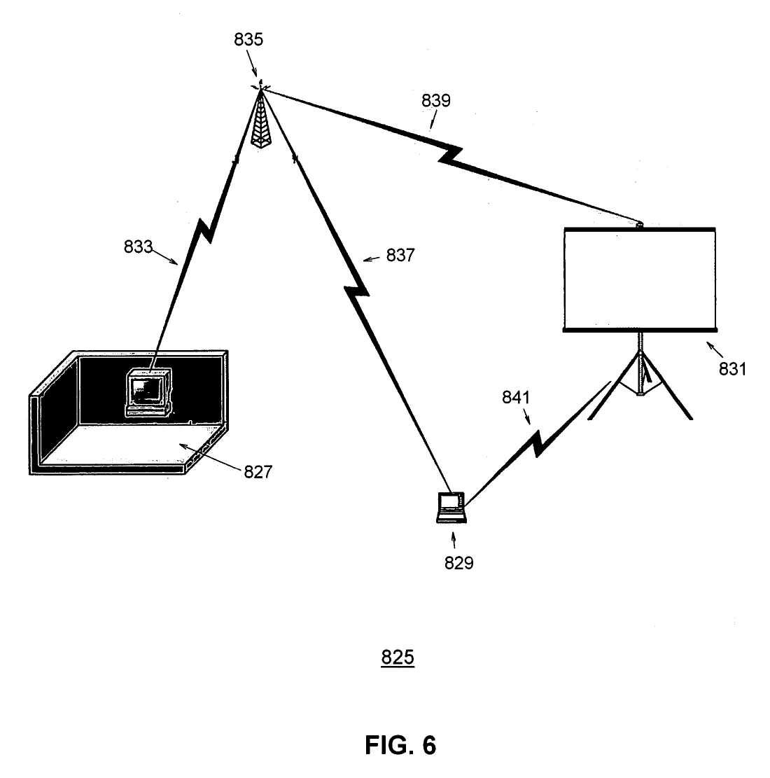

FIG. 6 graphically illustrates an alternate application embodiment of FIG. 5 of a videoconferencing system 825 having mobile capabilities according to the present invention. A fixed videoconferencing environment 827 communicates with mobile videoconferencing environment 829. Fixed videoconferencing environment 827 and/or mobile videoconferencing environment 829 further communicate with yet another mobile videoconferencing environment 831, such as a hostage environment. As discussed in reference to FIG. 5, the fixed videoconferencing environment 827 is a control center, or conference room, at a police station. Police out in the field utilize mobile videoconferencing equipment 829 such as a laptop, to communicate with the control center. Data is transmitted from the control center via radio frequency 833 to a radio tower 835. Radio tower 835 transmits the data via radio frequency 837 to the laptop and via radio frequency 839 to projection screen in the hostage environment. Additionally, hostages can communicate with the police in the field via radio frequency 841 or with the control center via radio frequencies 839, 833. Thus, communication links are established between the control center and the police in the field, the control center and the hostages, and between the police in the field and the hostages.

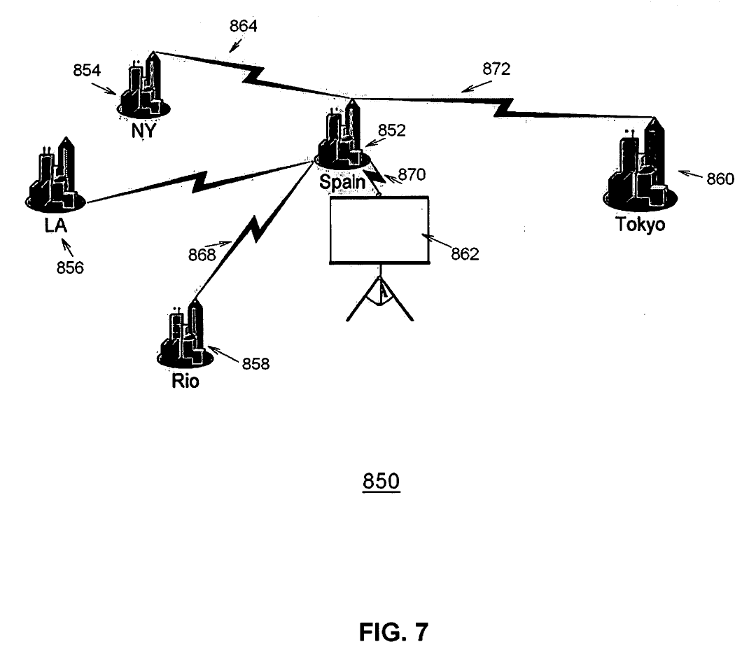

FIG. 7 graphically illustrates an application embodiment of a mobile videoconferencing system 850 having mobile capabilities according to the present invention. A fixed videoconferencing environment 852 communicates information to various other videoconferencing environments, fixed or mobile, 854, 856, 858, 860, 862. For example, fixed videoconferencing environment 852 is a fashion show in Spain. The fashion show is interactively communicated real-time to a videoconferencing environment 854 in New York via communication link 864 while simultaneously communicating the fashion show to a videoconferencing environment 856 in Los Angeles via link 866, videoconferencing environment 858 in Rio de Janeiro via link 868, videoconferencing environment 862, such as a beach on the other side of town from the fashion show in Spain via link 870, and videoconferencing environment 860 in Tokyo via link 872. Those viewing the fashion show from various locations around the world can ask questions of the models and designers.

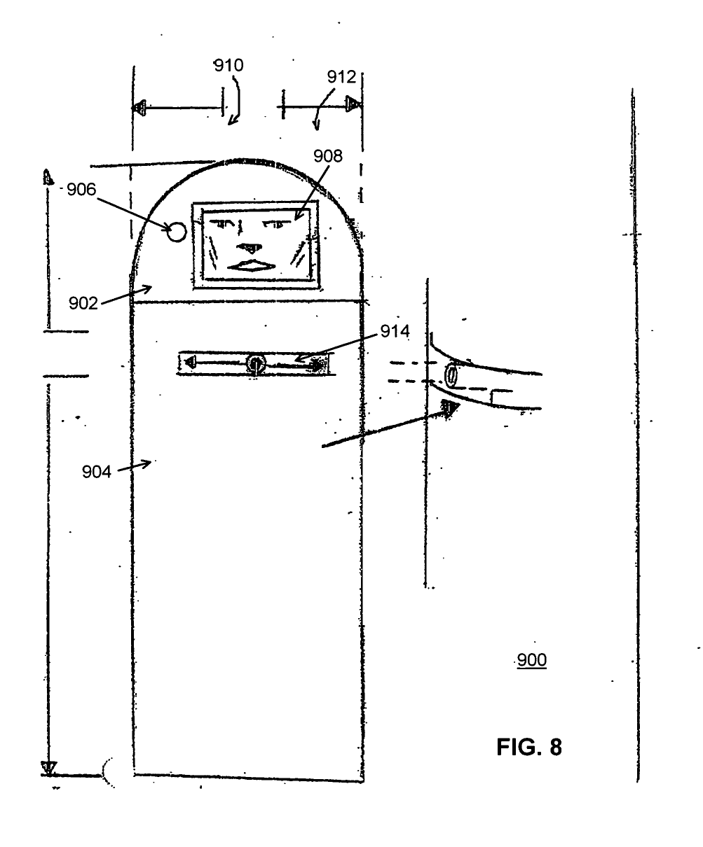

As shown in FIG. 8, the mobile videoconferencing components can be contained within a robot 900. Robot 900 includes a head portion 902 and body portion 904, which both can be bullet-proof for military applications. The head portion 902 includes a camera 906 to record images and a display device 908 to convey visual data, for example, the eyes of the robot can be a camera and the display device 908 can appear as an image of a face. It is further contemplated that the head portion 902 can rotate for 360° observation. The robot 900 further includes a microphone 910 to record aural information and audio monitor 912 to convey the aural information. The robot 900 can further include a weapon 914 that is moveable within the robot. For example, the camera 906 and microphone 910 communicate data back to a fixed videoconferencing environment. A user at the fixed videoconferencing environment receives visual and aural information real-time, such that an interactive communication occurs with users located at the robot. If desired, the user at the fixed videoconferencing environment can control the robot 900 to execute the weapon 914.

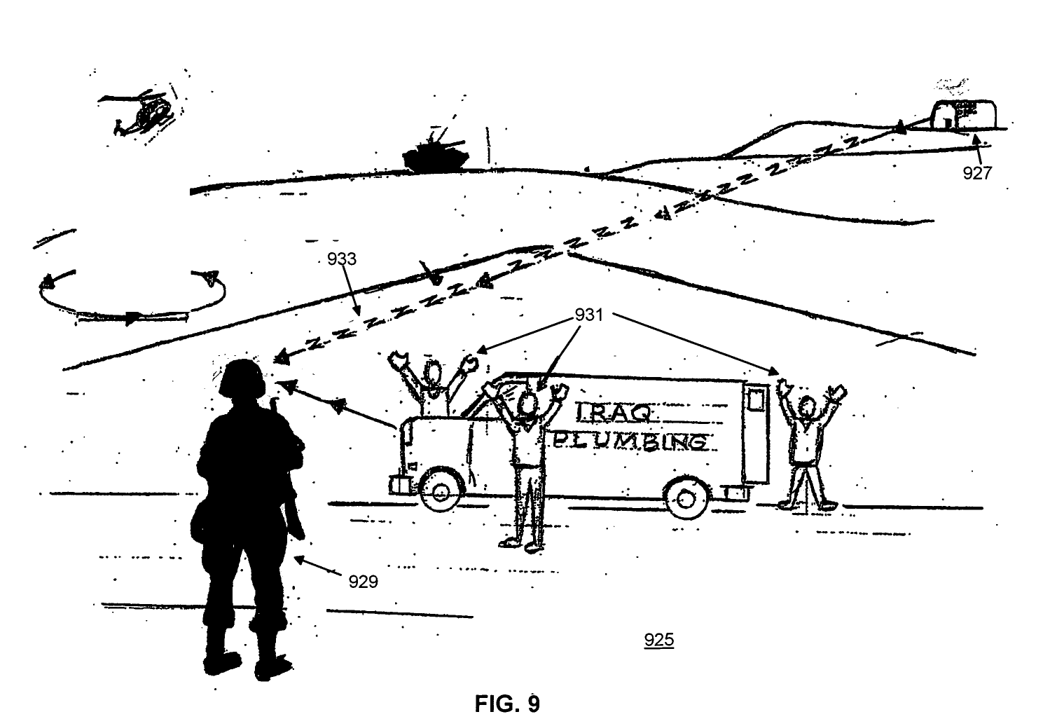

FIG. 9 graphically illustrates an application embodiment of a mobile videoconferencing system 925 having mobile capabilities according to the present invention. This embodiment includes a control center 927, portable sentry 929 and terrorists 931. Military personnel at the control center 927 can communicate with the terrorists 931 from a distance, via the sentry 929. Data from the control center 927 is communicated via link 933 to the sentry 929 real-time. This data is conveyed to the terrorists 931 on the display device of the sentry 929 and audio monitor packaged within the sentry 929. Data conveyed from the terrorists 931 is received by the camera and microphone also packaged with in the sentry 929. Visual and aural information data is communicated back to the control center 927 via link 933. Thus, the terrorists 931 can view on the display device a military general located at the control center 927, or even a military general located overseas. It is further contemplated that the terrorists 931 can communicate with both military generals via a split-screen display device. Besides visual and aural data, sensory and biological data can also be communicated via link 933 between the control center 927 and terrorist 931 via sentry 929.

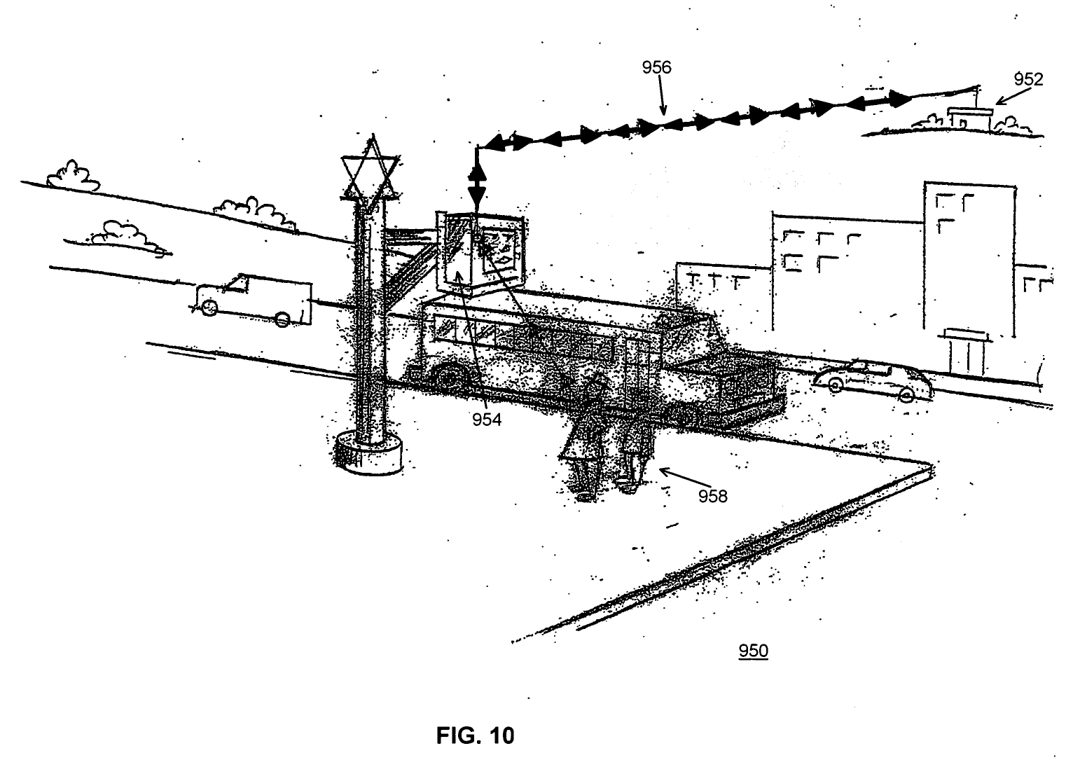

FIG. 10 graphically illustrates an application embodiment of a mobile videoconferencing system 950 having mobile capabilities according to the present invention. This embodiment includes a control center 952, security attendant 954 and transportation passengers 958. Personnel at the control center 952 can communicate with the passengers 958 from a distance, via the attendant 954. Data from the control center 952 is communicated via link 956 to the attendant 954 real-time. This data is conveyed to the passengers 958 on the display device and audio monitor packaged within the attendant 954. Data conveyed from the passengers 958 is received by the camera and microphone also packaged with in the attendant 954. Visual and aural information data is communicated back to the control center 952 via link 956. Thus, the passengers 958 can view on the display device of attendant 954 requests from the control center 927, such as an inspection of baggage before boarding the bus. It is further contemplated that the attendant 954 can assess sensory and biological data as well.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive uses of all modifications are reserved.

What is claimed is:

1. A system for real time mobile videoconferencing, comprising:
a first device for a plurality of persons at a first location to participate in real time in a video conference; and
a second device for at least one person at a second location to participate in real time in the video conference, wherein the second device includes a mobility capability so that the at least one person at the second location can be mobile while participating in the video conference and can view the plurality of persons at the first location.

2. The system according to claim 1, wherein the first device also includes a mobility capability so that at least one person at the first location can be mobile while participating in the video conference.

3. The system according to claim 1, wherein the first device employs a monitor, a speaker, a camera and a microphone that are all coupled to a CODEC that serves as an interface to and from an ISDN line over which audio and video communications with the second location occur.

4. The system according to claim 3, wherein the second device comprises a second CODEC that outputs communications received over the ISDN line from the first location to a first transmitter that transmits said communications to a first receiver coupled to a monitor that enables the at least one person at the second location to view and hear the plurality of persons at the first location.

5. The system according to claim 4, wherein the second device further comprises a camera and a second transmitter coupled to one another that transmit recorded audio and video signals of the at least one person at the second location to a second receiver that inputs said signals to the second CODEC for transmission over the ISDN line to the plurality of persons at the first location, thereby enabling the at least one person at the first location to hear and see the at least one person at the second location.

6. The system according to claim 1, wherein the system enables the at least one person at the second location to move freely around the second location thereby enabling the plurality of persons at the first location to be taken on a moving tour of the second location.

7. The system according to claim 6, wherein the plurality of persons at the first location can ask the at least one person at the second location to stop and examine an object of interest that the plurality of persons at the first location view, and the plurality persons at the first location can ask questions of another person encountered while touring the second location.

8. The system according to claim 5, wherein the first transmitter and first receiver, and the second transmitter and the second receiver are implemented as wireless components.

9. The system according to claim 5, wherein first transmitter and the first receiver, and the second transmitter and the second receiver are coupled to one another using lightweight, fiber-optic cable.

10. The system according to claim 5, wherein at least one of the first and second transmitter and receiver pairs are implemented using a combination of wireless and fiber-optically coupled components.

11. A system for real time mobile videoconferencing comprising:
a first videoconferencing device situated at a first location for a plurality of persons to participate in a video conference; and
a second videoconferencing device situated at a second location, wherein communications between the first and second videoconferencing devices occur in real time over a communications link, and wherein the second videoconferencing device includes components that provide a mobility capability so that a person at the second location can move freely around the second location thereby enabling the plurality of persons at the first location to be taken on a moving tour of the second location and view the plurality of persons at the first location.

12. The system according to claim 11, wherein the mobility capability is provided by components including a first transmitter that transmits communications received from the first location to a first receiver coupled to a monitor that enables at least one person at the second location to view and hear the plurality of persons at the first location, and further including a second transmitter that transmits recorded audio and video signals of the at least one person at the second location to a second receiver for transmission over the communicating link to the first location, thereby enabling the plurality of persons at the first location to hear and see the at least one person at the second location.

13. The system according to claim 11, wherein the system provides full duplex video and audio communications between the first and second locations.

14. The system according to claim 11, wherein communications occur between the first location and second location over the Internet.

15. The system according to claim 11, wherein communications occur between the first location and second location over a satellite system.

16. The system according to claim 11, wherein communications occur between the first location and second location over a high speed land line.

17. The system according to claim 11, wherein communications occur between the first location and second location over a telephone line.

18. The system according to claim 1, wherein communications occur between the first location and second location over a microwave system.

19. The system according to claim 11, wherein the mobility capability is provided by wireless components.

20. The system according claim 11, wherein the mobility capability is provided by fiber-optically coupled components.

21. The system according to claim 1, wherein the device at the second location includes a stationary transmitter/receiver pair and a remote mobile transmitter/receiver pair that provide full duplex audio/video communications between the stationary transmitter/receiver pair and the remote mobile transmitter/receiver pair.

22. The system according to claim 11, wherein the second videoconferencing device includes a first stationary transmitter/receiver pair and a second mobile transmitter/receiver pair, the system providing full duplex audio/video communications between the first transmitter/receiver pair and the second transmitter/receiver pair, the second, transmitter/receiver pair transmitting audio/video communications received from the second transmitter/receiver pair to the first location and transmitting audio/video signals received from the first location to the second transmitter/receiver pair.

23. A system for mobile videoconferencing, comprising:
a first transmitter/receiver pair at a first videoconferencing location, the first location having viewers; and
a second transmitter/receiver pair and a third transmitter/receiver pair at a second videoconferencing location, wherein videoconferencing communications occur between the first and second locations, the second transmitter/receiver pair and the third transmitter/receiver pair providing mobility to the system such that an operator at the second location can take the viewers at the first location on a mobile tour of the second location, the system providing full duplex audio/video communications between the second transmitter/receiver pair and the third transmitter/receiver pair and allows the operator at the second location to view the plurality of persons at the first location.

24. A method for mobile videoconferencing comprising:
providing a first device for participation in a real time videoconference and a second device for participation in said real time videoconference, wherein either or both of the first device and the second device are self-contained to provide mobility;
linking the first device and the second device such that visual and aural information may be exchanged between the first device and the second device; and
conveying the visual and aural information generally simultaneously for real time mobile videoconference.

25. The method of claim 24, wherein the step of linking the first device with the second device is established over a radio frequency network.

26. The method of claim 24, wherein the step of linking the first device with the second device is established over a satellite network.

27. The method of claim 24, wherein the step of linking the first device with the second device is established over a wide area network.

28. The method of claim 24, wherein the step of linking the first device with the second device is established over a local area network.

29. The method of claim 24, further comprising the step of storing said real time videoconference for later playback, archival, or other purposes.

30. A system for a real time videoconference comprising:
a first portable device including a first camera, a first microphone, a first display device, and a first audio monitor;
a second portable device including a second camera, a second microphone, a second display device, and a second audio monitor; and
a network linking said first portable device and said second portable device providing full duplex communication, wherein said first camera simultaneously communicates with said second display device, said first microphone simultaneously communicates with said second audio monitor, said first display device simultaneously communicates with said second camera and said first audio monitor simultaneously communicates with said second microphone.

31. The system of claim 30, wherein said first portable device is a cellular phone.

32. The system of claim 30, wherein said second portable device is a cellular phone.

33. The system of claim 30, wherein said first portable device is a laptop computer.

34. The system of claim 30, wherein said second portable device is a laptop computer.

35. A method for facilitating interactive communications between locations, comprising the steps of:
recording first location visual information and first location aural information at a first location and second location visual information and second location aural information at a second location;
communicatively linking the first location visual information and first location aural information and the second location visual information and the second location aural information such that the first location visual information and first location aural information and the second location visual information and the second location aural information are exchanged generally simultaneously; and
conveying the first location visual information and first location aural information to at least one second location participant located at the second location and the second location visual information and the second location aural information to at least one second location participant located at the first location, thereby establishing generally simultaneous visual and aural communication and interactivity between the at least one first location participant and the at least one second location participant.
